(19) United States
(12) Patent Application Publication
(10) Pub. No.: US 2015/0059476 A1
(43) Pub. Date: Mar. 5, 2015

(54) ACCELERATION SENSOR

(71) Applicant: SAMSUNGELECTRO-MECHANICS CO., LTD., Suwon-Si (KR)

(72) Inventors: Jong Woon Kim, Suwon-Si (KR); Tae Yoon Kim, Suwon-Si (KR); Seung Mo Lim, Suwon-Si (KR)

(73) Assignee: SAMSUNG ELECTRO-MECHANICS CO., LTD., Suwon-Si (KR)

(21) Appl. No.: 14/459,318

(22) Filed: Aug. 14, 2014

(30) Foreign Application Priority Data
Aug. 29, 2013 (KR) 10-2013-0103026

(51) Int. Cl. G01P 15/12

(52) U.S. Cl. CPC G01P 15/123
USPC 73/514.33

(57) ABSTRACT

Disclosed herein is an acceleration sensor including: a mass body part; a flexible beam having an electrode or a piezoresistor disposed thereon and having the mass body part coupled thereto; and a support part having the flexible beam connected thereto and supporting the flexible beam, wherein the mass body part, the flexible beam, and the support part are formed by coupling first and second substrates to each other, one surface of the first substrate is provided with a first masking pattern corresponding to the flexible beam, the mass body part, and the support part, and one surface of the second substrate is provided with a second masking pattern corresponding to the mass body part and the support part.

### CROSS REFERENCE TO RELATED APPLICATION

This application claims the benefit of Korean Patent Application No. 10-2013-0103026, filed on Aug. 29, 2013, entitled “Acceleration Sensor”, which is hereby incorporated by reference in its entirety into this application.

### BACKGROUND OF THE INVENTION

1. Technical Field

The present invention relates to an acceleration sensor.

2. Description of the Related Art

Generally, inertial sensors have been variously used in an automobile, an aircraft, a mobile communication terminal, a toy, and the like, and a three-axis acceleration and angular velocity sensor measuring X-axis, Y-axis, and Z-axis accelerations and angular velocities has been demanded and has been developed so as to have a high performance and a small size in order to detect a fine acceleration.

Among the inertial sensors as described above, an acceleration sensor has a technical feature of converting movement of a mass body and a flexible beam into an electrical signal, and is divided into a piezoresistive type acceleration sensor detecting the movement of the mass body from a resistance change of a piezoresistive element disposed in the flexible beam and a capacitive type acceleration sensor detecting the movement of the mass body from a capacitance change between the mass body and a fixed electrode.

In addition, in the piezoresistive type acceleration sensor, which uses an element having a resistance value changed by stress, for example, the resistance value is increased at a place at which tensile stress is distributed and is decreased at a place at which compressive stress is distributed.

Further, the piezoresistive type acceleration sensor according to the prior art including the Prior Art Document is vulnerable to impact since an area of the beam is decreased in order to increase sensitivity.

In addition, it is preferable that a piezoresistor is positioned at a distal end of a flexible part on which stress is concentrated in order to maximize sensitivity. However, when dispersion of a side wall angle is generated in an etching process for forming the flexible part, sensitivity is decreased at the distal end of the flexible part. Further, in order to improve sensitivity, a thickness of the mass body should be thick. However, the deeper the etching depth, the worse the dispersion of the side wall angle.

### PRIOR ART DOCUMENT

### Patent Document

(Patent Document 1) US 20060156818 A

### SUMMARY OF THE INVENTION

The present invention has been made in an effort to provide an acceleration sensor capable of improving sensitivity and decreasing sensitivity dispersion by having a multi-layer structure of first and second substrates and including the respective components formed by first and second masking patterns to allow a flexible beam to be formed at a shallow etching depth and allow a piezoresistor to be maintained at an optimal position.

According to a preferred embodiment of the present invention, there is provided an acceleration sensor including: a mass body part; a flexible beam having an electrode or a piezoresistor disposed thereon and having the mass body part coupled thereto; and a support part having the flexible beam connected thereto and supporting the flexible beam, wherein the mass body part, the flexible beam, and the support part are formed by coupling first and second substrates to each other, one surface of the first substrate is provided with a first masking pattern corresponding to the flexible beam, the mass body part, and the support part, and one surface of the second substrate is provided with a second masking pattern corresponding to the mass body part and the support part.

The flexible beam may be formed of the first substrate.

The mass body part may include: a first mass body formed of the first substrate; and a second mass body formed of the second substrate.

The first mass body may have the first masking pattern formed on one surface thereof facing the second mass body, and the second mass body may have the second masking pattern formed thereon.

The first masking pattern may have an area wider than that of the second masking pattern.

The support part may include a first support part formed of the first substrate and a second support part formed of the second substrate.

The first and second support parts may have the first masking pattern formed therebetween, and the second support part may have the second masking pattern formed thereon.

The first masking pattern may have an area wider than that of the second masking pattern.

The second support part may have an area narrower than that of the first support part.

The first masking pattern may be formed so as to face the second substrate.

The acceleration sensor may further include a lower cover coupled to one surface of the support part, wherein the second masking pattern is formed so as to face the lower cover.

According to another preferred embodiment of the present invention, there is provided an acceleration sensor including: a mass body part; a flexible beam having an electrode or a piezoresistor disposed thereon and having the mass body part coupled thereto; and a support part having the flexible beam connected thereto and supporting the flexible beam, wherein the mass body part, the flexible beam, and the support part are formed by coupling first and second substrates to each other, and one surface of the first substrate is provided with a first masking pattern corresponding to the flexible beam, the mass body part, and the support part.

The flexible beam may be formed of the first substrate.

The mass body part may include: a first mass body formed of the first substrate; and a second mass body formed of the second substrate.

The first and second mass bodies may have the first masking pattern formed therebetween.

The first mass body may have an area wider than that of the second mass body.

The support part may include a first support part formed of the first substrate and a second support part formed of the second substrate.

The first and second support parts may have the first masking pattern formed therebetween.

The first support part may have an area wider than that of the second support part.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a plan view schematically illustrating an acceleration sensor according to a preferred embodiment of the present invention;

FIG. 2 is a schematic cross-sectional view of the acceleration sensor taken along the line A-A of FIG. 1;

FIG. 3 is a schematic cross-sectional view of the acceleration sensor taken along the line B-B of FIG. 1; and

FIG. 4 is a schematic cross-sectional view of an acceleration sensor according to another preferred embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

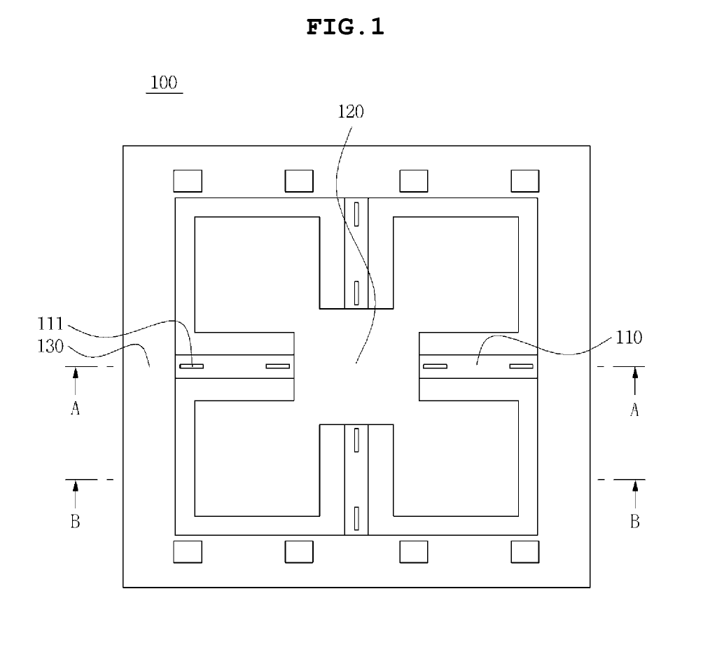

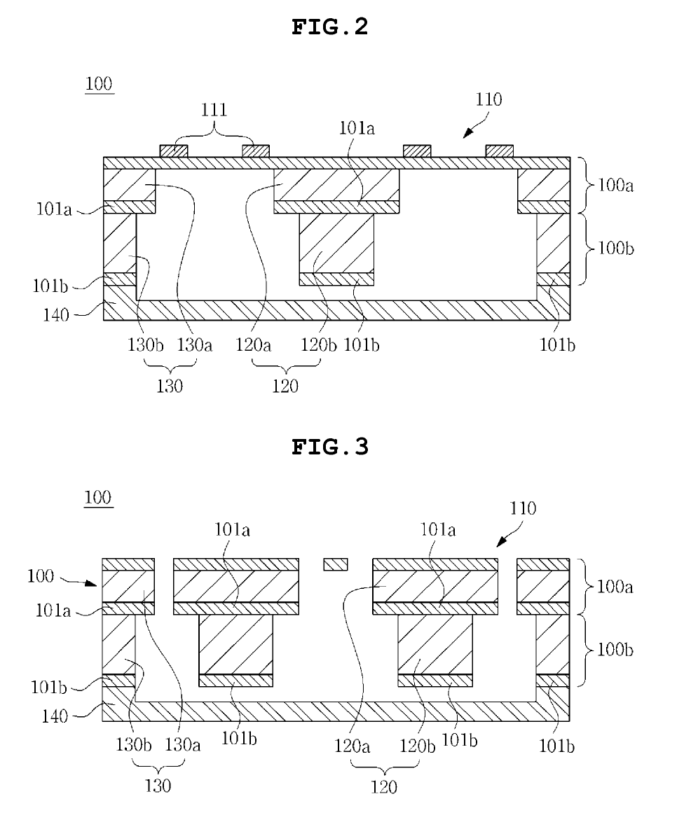

FIG. 1 is a plan view schematically illustrating an acceleration sensor according to a preferred embodiment of the present invention; FIG. 2 is a schematic cross-sectional view of the acceleration sensor taken along the line A-A of FIG. 1; and FIG. 3 is a schematic cross-sectional view of the acceleration sensor taken along the line B-B of FIG. 1.

As illustrated in FIGS. 1 to 3, the acceleration sensor 100 is configured to include a flexible beam 110, a mass body part 120, and a support part 130.

More specifically, the acceleration sensor 100 is formed by coupling first and second substrates 100a and 100b to each other and etching predetermined patterns.

To this end, one surface of the first substrate 100a is provided with a first masking pattern 101a corresponding to the flexible beam 110, the mass body part 120, and the support part 130, and one surface of the second substrate 100b is provided with a second masking pattern 101b corresponding to the mass body part and the support part.

In addition, the respective components of the acceleration sensor 100 are formed only of the first substrate 100a or are formed of the first and second substrates 100a and 100b.

That is, the flexible beam 110 is formed of the first substrate 100a, and the mass body part 120 may include a first mass body 120a formed of the first substrate 100a and a second mass body 120b formed of the second substrate 100b.

In addition, the first mass body 120a has the first masking pattern 101a formed on one surface thereof facing the second mass body 120b, and the second mass body 120b has the second masking pattern 101b formed thereon.

Further, the first masking pattern 101a has an area wider than that of the second masking pattern 101b. Therefore, the first mass body has an area wider than that of the second mass body.

The reason is that etching is performed by the second masking pattern and is then performed by the first masking patter, such that sequential etching is performed.

Further, the support part 130 includes a first support part 130a formed of the first substrate 100a and a second support part 130b formed of the second substrate 100b.

Further, the first and second support parts 130a and 130b have the first masking pattern formed therebetween, and the second support part has the second masking pattern formed thereon. In addition, the first masking pattern 101a has an area wider than that of the second masking pattern 101b. Therefore, the second support part 130b has an area narrower than that of the first support part 130a.

In addition, the first masking pattern 101a for forming the flexible beam 110, the first mass body 120a, and the first support part 130a is formed on one surface of the first substrate 100a so as to face the second substrate 100b.

In addition, the second masking pattern 101b for forming the second mass body 120b and the second support part 130b is formed on one surface of the second substrate 100b so as to face a lower cover 140.

As described above, the acceleration sensor 100 according to the preferred embodiment of the present invention has a multi-layer structure of the first and second substrates 100a and 100b and includes the respective components formed by the first and second masking patterns 101a and 101b to allow the flexible beam to be formed at a shallow etching depth and allow a piezoresistor 111 to be maintained at an optimal position, thereby making it possible to improve sensitivity and decrease sensitivity dispersion.

Hereinafter, the respective components of the acceleration sensor according to the preferred embodiment of the present invention and organic coupling between the respective components will be described in more detail.

More specifically, the flexible beam 110 has a plate shape and is formed of a flexible substrate such as a membrane, a beam, or the like, having elasticity so that the mass body part 120 may be displaced.

In addition, the flexible beam 110 has the piezoresistor 111 formed on one surface thereof.

Further, the mass body part 120 is coupled to one surface of the flexible beam 110 and is displaced by inertial force, external force, Coriolis force, driving force, or the like.

Further, the support part 130 is coupled to one surface of the flexible beam and supports the flexible beam in a floated state so that the mass body part 120 may be displaced.

Here, the mass body part 120 is positioned at a central portion of the flexible beam 110, the support part 130 has a hollow shape, such that the mass body part 120 is positioned in a hollow part so as to be displaceable, and the support part 130 is positioned at an edge portion of the flexible beam 110 to secure a space in which the mass body part 120 may be displaced.

In addition, the mass body part 120 may have a square pillar shape, and the support part 130 may have a cylindrical shape. Further, the mass body part 120 and the support part 130 are not limited to having the above-mentioned shape, but may have all shapes known in the art.

In the case in which an inertial sensor according to the preferred embodiment of the present invention is configured as described above and is implemented by the acceleration sensor and external force is generated, a moment is generated by the external force, such that the mass body part 120 is moved, a resistance value of the piezoresistor 111 of the flexible beam 110 is changed by the displacement of the mass body part 120, and the resistance value is detected to calculate an acceleration.

In addition, the acceleration sensor 100 according to the preferred embodiment of the present invention may further include a lower cover 140 coupled to one surface of the support part 130 so as to cover the mass body part 120.

In addition, the acceleration sensor 100 according to the preferred embodiment of the present invention may further include an upper cover (not illustrated) coupled to one surface of the support part 130 so as to cover the piezoresistor 111.

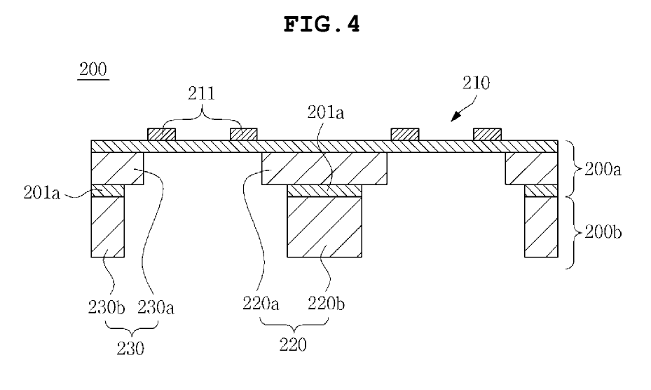

FIG. 4 is a schematic cross-sectional view of an acceleration sensor according to another preferred embodiment of the present invention. As illustrated in FIG. 4, the acceleration sensor according to another preferred embodiment of the present invention is different from the acceleration sensor according to the preferred embodiment of the present invention illustrated in FIG. 1 in that a masking pattern exposed to the outside does not remain.

As illustrated in FIG. 4, the acceleration sensor 200 is configured to include a flexible beam 210, a mass body part 220, and a support part 230.

More specifically, the acceleration sensor 200 is formed by coupling first and second substrates 200a and 200b to each other and etching predetermined patterns.

To this end, one surface of the first substrate 200a is provided with a first masking pattern 201a corresponding to the flexible beam 210, the mass body part 220, and the support part 230.

Therefore, the respective components of the acceleration sensor 200 are formed only of the first substrate 200a or are formed of the first and second substrates 200a and 200b.

That is, the first flexible beam 210 is formed of the first substrate 200a, and the mass body part 220 may include a first mass body 220a formed of the first substrate 200a and a second mass body 220b formed of the second substrate 200b.

In addition, the first and second mass bodies 220a and 220b have the first masking pattern 201a formed therebetween.

In addition, the first mass body 220a may have an area wider than that of the second mass body 220b.

Further, the support part 230 includes a first support part 230a formed of the first substrate 200a and a second support part 230b formed of the second substrate 200b.

In addition, the first masking pattern 201a is formed between the first and second support parts 230a and 230b.

In addition, the first support part 230a may have an area wider than that of the second support part 230b.

In addition, a second masking pattern (not illustrated) for forming the second mass body 220b and the second support part 230b is formed on one surface of the second substrate 200b so as to face a lower cover (not illustrated).

The first masking pattern 201a exposed to the outside and the second masking pattern are additionally etched, such that the acceleration sensor 200 illustrated in FIG. 4 is completed.

According to the preferred embodiment of the present invention, it is possible to obtain an acceleration sensor capable of improving sensitivity and decreasing sensitivity dispersion by having a multi-layer structure of first and second substrates and including the respective components formed by first and second masking patterns to allow a flexible beam to be formed at a shallow etching depth and allow a piezoresistor to be maintained at an optimal position.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. An acceleration sensor comprising:
a mass body part;
a flexible beam having an electrode or a piezoresistor disposed thereon and having the mass body part coupled thereto; and
a support part having the flexible beam connected thereto and supporting the flexible beam,
wherein the mass body part, the flexible beam, and the support part are formed by coupling first and second substrates to each other, one surface of the first substrate is provided with a first masking pattern corresponding to the flexible beam, the mass body part, and the support part, and one surface of the second substrate is provided with a second masking pattern corresponding to the mass body part and the support part.

2. The acceleration sensor as set forth in claim 1, wherein the flexible beam is formed of the first substrate.

3. The acceleration sensor as set forth in claim 1, wherein the mass body part includes:
a first mass body formed of the first substrate; and
a second mass body formed of the second substrate.

4. The acceleration sensor as set forth in claim 3, wherein the first mass body has the first masking pattern formed on one surface thereof facing the second mass body, and the second mass body has the second masking pattern formed thereon.

5. The acceleration sensor as set forth in claim 4, wherein the first masking pattern has an area wider than that of the second masking pattern.

6. The acceleration sensor as set forth in claim 1, wherein the support part includes a first support part formed of the first substrate and a second support part formed of the second substrate.

7. The acceleration sensor as set forth in claim 6, wherein the first and second support parts have the first masking pattern formed therebetween, and the second support part has the second masking pattern formed thereon.

8. The acceleration sensor as set forth in claim 7, wherein the first masking pattern has an area wider than that of the second masking pattern.

9. The acceleration sensor as set forth in claim 7, wherein the second support part has an area narrower than that of the first support part.

10. The acceleration sensor as set forth in claim 1, wherein the first masking pattern is formed so as to face the second substrate.

11. The acceleration sensor as set forth in claim 1, further comprising a lower cover coupled to one surface of the support part, wherein the second masking pattern is formed so as to face the lower cover.

12. An acceleration sensor comprising:
a mass body part;
a flexible beam having an electrode or a piezoresistor disposed thereon and having the mass body part coupled thereto; and
a support part having the flexible beam connected thereto and supporting the flexible beam,
wherein the mass body part, the flexible beam, and the support part are formed by coupling first and second substrates to each other, and one surface of the first substrate is provided with a first masking pattern corresponding to the flexible beam, the mass body part, and the support part.

13. The acceleration sensor as set forth in claim 12, wherein the flexible beam is formed of the first substrate.

14. The acceleration sensor as set forth in claim 12, wherein the mass body part includes:
a first mass body formed of the first substrate; and
a second mass body formed of the second substrate.

15. The acceleration sensor as set forth in claim 14, wherein the first and second mass bodies have the first masking pattern formed therebetween.

16. The acceleration sensor as set forth in claim 15, wherein the first mass body has an area wider than that of the second mass body.

17. The acceleration sensor as set forth in claim 12, wherein the support part includes a first support part formed of the first substrate and a second support part formed of the second substrate.

18. The acceleration sensor as set forth in claim 17, wherein the first and second support parts have the first masking pattern formed therebetween.

19. The acceleration sensor as set forth in claim 17, wherein the first support has an area wider than that of the second support part.
